(19) United States
(12) Patent Application Publication
(10) Pub. No.: US 2022/0330489 A1
(43) Pub. Date: Oct. 20, 2022

(54) LIGHT SOURCE MODULE AND PLANTS CULTIVATION DEVICE INCLUDING THE SAME

(71) Applicant: SEOUL VIOSYS CO., LTD., Gyeonggi-do (KR)

(72) Inventors: Hyun Su SONG, Gyeonggi-do (KR); Se Ryung KIM, Gyeonggi-do (KR); Jin Won KIM, Gyeonggi-do (KR)

(73) Assignee: SEOUL VIOSYS CO., LTD., Gyeonggi-do (KR)

(21) Appl. No.: 17/684,982

(22) Filed: Mar. 2, 2022

Related U.S. Application Data
(60) Provisional application No. 63/156,009, filed on Mar. 3, 2021.
(60) Provisional application No. 63/314,138, filed on Feb. 25, 2022.

(51) Int. Cl. A01G 7/04; F21V 21/14

(52) U.S. Cl. CPC A01G 7/045; F21V 21/14; F21Y 2113/10

(57) ABSTRACT

A light source module for plant cultivation includes a first light source unit emitting a first type of light suitable for growing a plant, a second light source unit emitting a second type of light suitable for growing the plant, and a third light source unit emitting a third type of light suitable for increasing the content of phytochemicals in the plant. The first light source unit, the second light source unit, and the third light source unit are operated independently of one another. The first type of light and the second type light are visible light having different peak wavelengths. The third type of light includes at least one selected from among UVA, UVB, UVC, and near-UV light.

### CROSS-REFERENCE TO RELATED APPLICATION

This application claims priority from and the benefit of U.S. Provisional Patent Application No. 63/156,009, filed on Mar. 3, 2021, and U.S. Provisional Patent Application No. 63/314,138, filed on Feb. 25, 2022, each of which is hereby incorporated by reference for all purposes as if fully set forth herein.

### TECHNICAL FIELD

Embodiments of the present disclosure relate to a light source module for plant cultivation and a plant cultivation apparatus including the same.

### BACKGROUND

Plants produce organic matter from carbon dioxide and water using light energy through photosynthesis. Plants use chemical energy of organic matter obtained through photosynthesis as nutrients for growth.

As a luminaire for plant cultivation, various light sources that can replace sunlight have been developed and put into use. Luminaires most used for plant cultivation include incandescent lamps and fluorescent lamps. However, most typical luminaires for plant cultivation are used only for the purpose of promoting photosynthesis of plants.

Plants contain phytochemicals that have beneficial effects on a subject in need thereof. Plant phytochemicals have various effects such as antioxidant, anticancer, and anti-inflammatory effects and are used to treat various diseases and symptoms.

In order to increase the phytochemical content of plants, treating plants with UV light to apply stress to the plants is used recently.

The above information disclosed in this Background section is only for understanding of the background of the inventive concepts, and, therefore, it may contain information that does not constitute prior art.

### SUMMARY

Embodiments of the present disclosure provide a light source module that can increase the phytochemical content of a plant while helping the plant to grow, and a plant cultivation apparatus including the same.

Embodiments of the present disclosure provide a light source module that can supply a plant with an appropriate amount of light for each growth stage of the plant, and a plant cultivation apparatus including the same.

Embodiments of the present disclosure provide a plant cultivation apparatus that can supply a plant with an appropriate amount of nutrients for each growth stage of the plant.

Embodiments of the present disclosure provide a plant cultivation apparatus that can prevent a plant from being damaged by heat from the light source module.

In accordance with one aspect of the present disclosure, there is provided a light source module including: a first light source unit emitting a first type of light suitable for growing a plant; a second light source unit emitting a second type of light suitable for growing the plant; and a third light source unit emitting a third type of light suitable for increasing the content of phytochemicals in the plant. The first light source unit, the second light source unit, and the third light source unit may be operated independently of one another. Here, the first type of light and the second type of light are visible light and have different peak wavelengths. In addition, the third type of light may include at least one selected from among UVA, UVB, UVC, and near-UV light.

In one embodiment, the first light source unit, the second light source unit, and the third light source unit may be operated simultaneously during a preset light period.

In another embodiment, the first light source unit and the second light source unit may be operated during a preset light period. Here, the first light source unit and the second light source unit may be operated simultaneously for at least some period of time.

The third light source unit may be operated for at least a portion of a period of time for which the first light source unit is operated.

Alternatively, the third light source unit may be operated for at least a portion of a period of time for which the second light source unit is operated.

Alternatively, the third light source may be operated during a preset dark period.

The light source module may supply the plant in a primary growth stage with light at an intensity of about 500 μmol/m²s during a preset light period. Here, the light period may be 18 hours and a dark period may be 6 hours.

Here, the primary growth stage may be a period of time after planting of the plant in a cultivation tray and before flowering or fruiting of the plant.

The light source module may supply the plant in a secondary growth stage with light at an intensity of about 1,000 μmol/m²s during a preset light period. Here, the light period may be 12 hours and a dark period may be 6 hours.

Here, the secondary growth stage may be a period of time after the primary growth stage and before harvest of flowers or fruits of the plant.

The phytochemicals may include cannabinoids.

For example, the phytochemicals may include at least one selected from among Δ9-tetrahydrocannabinol (Δ9-THC), tetrahydrocannabinolic acid (THCA), Δ8-tetrahydrocannabinol (Δ8-THC), cannabinol (CBN), cannabichromene (CBC), cannabicyclol (CBL), cannabichromenic acid (CBCA), cannabidiol (CBD), cannabidiolic acid (CBDA), cannabigerol (CBG), and cannabigerolic acid (CBGA).

The plant may include cannabis.

In accordance with another aspect of the present disclosure, there is provided a plant cultivation apparatus including: a cultivation tray adapted to allow a plant to be planted therein and supporting the plant during growth; a moisture supply unit supplying moisture to the plant; and a light source module supplying light to the plant. The light source module is disposed above the cultivation tray and supplies light to the plant during at least one of preset light and dark periods.

The light source module includes a first light source unit emitting a first type of light suitable for growing the plant, a second light source unit emitting a second type of light suitable for growing the plant, and a third light source unit emitting a third type of light suitable for increasing the content of phytochemicals in the plant. The first light source unit, the second light source unit, and the third light source unit may be operated independently of one another. The first type of light and the second type light may be visible light and have different peak wavelengths. The third type of light may include at least one selected from among UVA, UVB, UVC, and near-UV light.

In one embodiment, the first light source unit, the second light source unit, and the third light source unit may be operated simultaneously during the light period.

In another embodiment, the first light source unit and the second light source unit may be operated during the light period. Here, the first light source unit and the second light source unit may be operated simultaneously for at least some period of time.

Here, the third light source unit may be operated for at least a portion of a period of time for which the first light source unit is operated.

Alternatively, the third light source unit may be operated for at least a portion of a period of time for which the second light source unit is operated.

Alternatively, the third light source may be operated during the dark period.

The plant cultivation apparatus may further include: a moving unit moving the light source module to adjust a distance between the light source module and the plant.

The moving unit may control a location of the light source module such that a distance of about 30 cm is maintained between the light source module and the plant.

The plant cultivation apparatus may further include: a moisture storage unit storing moisture to be supplied to the moisture supply unit.

The moisture may be a nutrient solution containing nutrients needed by the plant.

The light source module may supply the plant in a primary growth stage with light at an intensity of about 500 μmol/m²s during the light period. Here, the light period may be 18 hours and the dark period may be 6 hours.

The primary growth stage may be a period of time after planting of the plant in the cultivation tray and before flowering or fruiting of the plant.

The light source module may supply the plant in a secondary growth stage with light at an intensity of about 1,000 μmol/m²s during the light period. Here, the light period may be 12 hours and the dark period may be 6 hours.

The secondary growth stage may be a period of time after the primary growth stage and before harvest of flowers or fruits of the plant.

The phytochemicals may include cannabinoids.

For example, the phytochemicals may include at least one selected from among Δ9-tetrahydrocannabinol (Δ9-THC), tetrahydrocannabinolic acid (THCA), Δ8-tetrahydrocannabinol (Δ8-THC), cannabinol (CBN), cannabichromene (CBC), cannabicyclol (CBL), cannabichromenic acid (CBCA), cannabidiol (CBD), cannabidiolic acid (CBDA), cannabigerol (CBG), and cannabigerolic acid (CBGA).

The plant may include cannabis.

The light source module and the plant cultivation apparatus according to the embodiments of the present disclosure can increase the phytochemical content of a plant while helping the plant to grow by supplying the plant with light in various wavelength ranges.

In addition, the light source module and the plant cultivation apparatus according to the embodiments can supply a plant with an appropriate amount of light for each growth stage of the plant through adjustment of photoperiod and light intensity depending on the growth stage of the plant.

Further, the plant cultivation apparatus according to the embodiments can supply a plant with an appropriate amount of nutrients for each growth stage of the plant through adjustment of the supply of moisture depending on the growth stage of the plant.

Moreover, the plant cultivation apparatus according to the embodiments can prevent a plant from being damaged by heat from the light source module while exposing the entire plant to light through control of the distance between the plant and the light source module.

It is to be understood that both the foregoing general description and the following detailed description are exemplary and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this specification, illustrate exemplary embodiments of the disclosure, and together with the description serve to explain the inventive concepts.

FIG. 1 is an exemplary view of a light source module according to one embodiment of the present disclosure.

FIG. 2 is a block diagram of the light source module according to the embodiment.

FIG. 3 shows one exemplary spectrum of a first type of light emitted from a first light source unit of the light source module according to the embodiment.

FIG. 4 shows another exemplary spectrum of the first type of light emitted by the first light source unit of the light source module according to the embodiment.

FIG. 5 is an exemplary spectrum of a second type of light emitted from a second light source unit of the light source module according to the embodiment.

FIG. 6 to FIG. 16 each show an exemplary spectrum of light emitted from a third light source unit of the light source module according to the embodiment where:

FIG. 6 illustrates a spectrum of UVC emitted from a third light source unit having a peak in the wavelength range of 270 nm to 280 nm.

FIG. 7 illustrates a spectrum of UVC emitted from the third light source unit having a peak in the wavelength range of 280 nm to 290 nm.

FIG. 8 illustrates a spectrum of UVB emitted from the third light source unit having a peak in the wavelength range of 290 nm to 300 nm.

FIG. 9 illustrates a spectrum of UVB emitted from the third light source unit having a peak in the wavelength range of 300 nm to 320 nm.

FIG. 10 illustrates a spectrum of UVA emitted from the third light source unit having a peak in the wavelength range of 340 nm to 370 nm.

FIG. 11 illustrates a spectrum of UVA emitted from the third light source unit having a peak in the wavelength range of 370 nm to 380 nm.

FIG. 12 illustrates a spectrum of UVA emitted from the third light source unit having a peak in the wavelength range of 380 nm to 390 nm.

FIG. 13 illustrates a spectrum of UVA emitted from the third light source unit having a peak in the wavelength range of 390 nm to 400 nm.

FIG. 14 illustrates a spectrum of near-UV light emitted from the third light source unit having a peak in the wavelength range of 400 nm to 410 nm.

FIG. 15 illustrates a spectrum of near-UV light emitted from the third light source unit having a peak in the wavelength range of 410 nm to 430 nm.

FIG. 16 illustrates a spectrum of light emitted from the third light source unit having a peak in the wavelength range of 820 nm to 890 nm.

FIG. 17 is an exemplary view of a plant cultivation apparatus according to one embodiment of the present disclosure.

### DETAILED DESCRIPTION OF EMBODIMENTS

Reference will now be made in detail to various embodiments, examples of which are illustrated in the accompanying drawings. It should be understood that the embodiments are provided for complete disclosure and thorough understanding of the present disclosure by those skilled in the art. Therefore, the present disclosure is not limited to the following embodiments and may be embodied in different ways. In addition, the drawings may be exaggerated in width, length, and thickness of components for descriptive convenience and clarity only. Like components will be denoted by like reference numerals throughout the specification.

Hereinafter, exemplary embodiments of the present disclosure will be described with reference to the accompanying drawings.

FIG. 1 is an exemplary view of a light source module according to one embodiment of the present disclosure.

According to this embodiment, the light source module 100 supplies a plant with light needed for growth of the plant.

According to this embodiment, the light source module 100 may include a support member 150, a first light source unit 110, a second light source unit 120, and a third light source unit 130.

The first light source unit 110, the second light source unit 120, and the third light source unit 130 are mounted on the support member 150.

The support member 150 may serve as a substrate while supporting the first light source unit 110, the second light source unit 120, and the third light source unit 130. For example, the support member 150 may include an interconnect. Here, the interconnect may be any structure that allows electricity to be supplied to the light source module 100 therethrough, such as a metal interconnect and a wire.

The first light source unit 110, the second light source unit 120 and the third light source unit 130 may emit light having different peak wavelengths. Here, at least two of emission spectra of the first light source unit 110, the second light source unit 120, and the third light source unit 130 may partially overlap each other over a certain wavelength range.

The first light source unit 110 may emit a first type of light suitable for photosynthesis of the plant. The first type of light emitted from the first light source unit 110 may be visible light. For example, the first type of light may be white light.

The first light source unit 110 may include at least one white light source. The white light source may include multiple light emitting diodes emitting different colors of light. For example, the white light source may include a blue light emitting diode, a red light emitting diode, and a green light emitting diode. Accordingly, the white light source may emit white light produced by mixing of different colors of light emitted from the respective light emitting diodes.

Alternatively, the first light source unit 110 may emit visible light other than white light. The first light source unit 110 may include multiple identical light emitting diodes emitting visible light other than white light. Alternatively, the first light source unit 110 may include multiple light emitting diodes, and emission spectra of at least two of the multiple light emitting diodes partially overlap each other over a certain wavelength range.

Alternatively, the white light source may include a light emitting diode emitting blue light or UV light and a phosphor covering the light emitting diode. Accordingly, the white light source may emit white light produced by mixing of light emitted from the light emitting diode and light emitted from the phosphor upon excitation by the light emitting diode.

Alternatively, the first light source unit 110 may include multiple light sources emitting different colors of light. For example, the first light source unit 110 may include a blue light source including a blue light emitting diode, a red light source including a red light emitting diode, and a green light source including a green light emitting diode. Accordingly, the first light source unit 110 may emit white light produced by mixing of different colors of light emitted from the respective light sources.

The first light source unit 110 may provide a day length needed for the plant to grow while helping the plant to perform photosynthesis.

The second light source unit 120 may emit a second type of light suitable for photosynthesis of the plant. The second type of light emitted from the second light source unit 120 may be visible light. Here, the second type of light emitted from the second light source unit 120 may have a different peak wavelength than the first type of light. For example, the second type of light may be red light. The second light source unit 120 may include at least one red light source. The red light source may include a red light emitting diode.

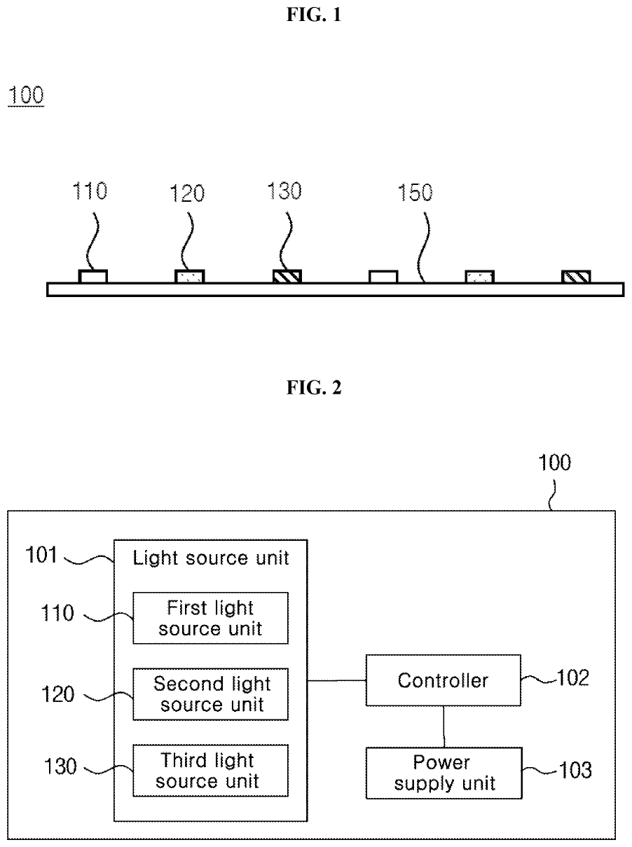

FIG. 2 is a block diagram of the light source module of FIG. 1. Referring to FIG. 2, the light source module 100 may include a light source unit 101, a controller 102, and a power supply unit 103. The light source unit 101 may include the first light source unit 110, the second light source unit 120, and the third light source unit 130.

The power supply unit 103 stores electricity needed to operate the light source unit 101. For example, the power supply unit 103 may be a battery. In one embodiment, the power supply unit 103 may be disposed inside the support member 150 (see FIG. 1). However, it should be understood that the light source module 100 according to the present disclosure is not limited thereto. The power supply unit 103 may be disposed outside the light source module 100. Alternatively, the power supply unit 103 may be omitted. Here, the interconnect of the support member 150 (see FIG. 1) may be directly connected to the power supply unit outside the light source module 100. Alternatively, the interconnect of the support member 150 (see FIG. 1) may be connected to the power supply unit outside the light source module 100 via an electrical wire.

The controller 102 may control operation of the light source unit 101. For example, the controller 102 may allow the light source unit 101 to emit light by supplying electricity from the power supply unit 103 to the light source unit 101. In addition, the controller 102 may allow the light source unit 101 to stop emitting light by shutting off supply of electricity from the power supply unit 103 to the light source unit 101.

The controller 102 may individually control each of the first light source unit 110, the second light source unit 120, and the third light source unit 130. In addition, the controller 102 may control each of the light source units to operate at a preset time. The controller 102 may be a circuit including the interconnect of the support member 150 (see FIG. 1). Alternatively, the controller 102 may be a circuit chip mounted on the support member 150 (see FIG. 1).

FIG. 3 shows one exemplary spectrum of the first type of light emitted from the first light source unit 110 as shown in FIG. 1. Referring to FIG. 3, the first type of light is white light having a peak in the blue wavelength range, which can promote photosynthesis of the plant. Blue light can improve leaf development and resistance to environmental stress of the plant. Accordingly, the first type of light, which has a peak in the blue wavelength range, helps the plant to develop leaves and have good resistance to environmental stress.

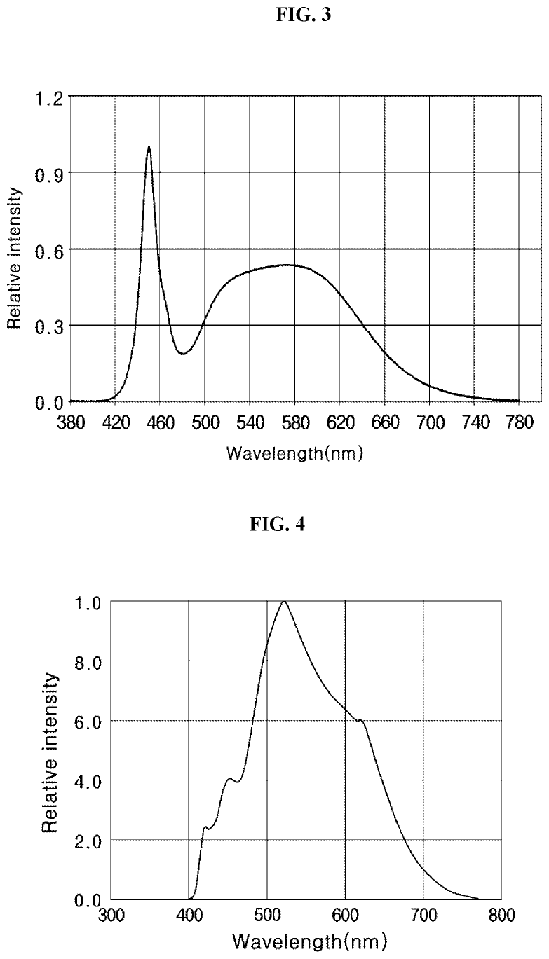

FIG. 4 shows another exemplary spectrum of the first type of light emitted from the first light source unit 110 (see FIG. 1). Referring to FIG. 4, the first light is white light having multiple peak wavelengths. According to this embodiment, the first light source unit 110 (see FIG. 1) may supply the plant with the first type of light, which is visible light having multiple peaks distributed over various wavelength ranges. Here, one of the multiple peaks may be located in the short-wavelength visible range and the others may be located in the long-wavelength visible range.

However, it should be understood that the first type of light emitted from the first light source unit 110 is not limited to light having the spectrum shown in FIG. 3 or FIG. 4. For example, the first type of light emitted from the first light source unit 110 may be light having a similar spectrum to sunlight. For example, the first type of light may have a spectrum having multiple similar intensity peaks over the entire visible range. Alternatively, the first type of light emitted from the first light source unit 110 may be light having a peak in each of the blue, green, and red wavelength ranges.

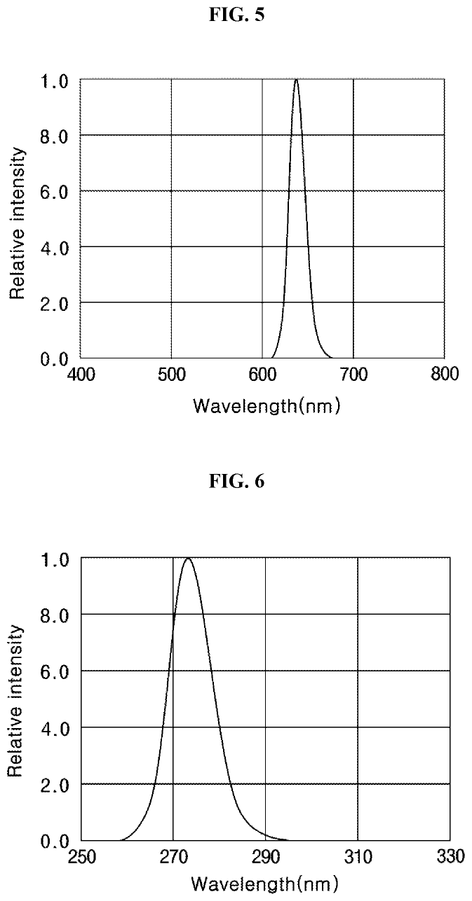

FIG. 5 shows an exemplary spectrum of the second type of light emitted from the second light source unit 120 (see FIG. 1). Referring to FIG. 5, the second type of light is red light having a peak in the red wavelength range. The second light source unit 120 may promote photosynthesis of the plant by supplying red light to the plant.

According to the embodiment of the present disclosure, the plant may grow through photosynthesis using at least one of the first type of light emitted from the first light source unit 110 and the second type of light emitted from the second light source unit 120. In addition, each of the first type of light emitted from the first light source unit 110 and the second type of light emitted from the second light source unit 120 may have a peak with a full width at half maximum of 30 nm or less.

The third light source unit 130 may emit a third type of light suitable for increasing the phytochemical content of the plant. The third type of light emitted from the third light source unit 130 may be at least one of UV light and near-UV light. For example, the third light source unit 130 may include a UV light source emitting UV light or near-UV light. The UV light source may include a UV light emitting diode.

FIG. 6 to FIG. 16 each show an exemplary spectrum of light emitted from the third light source unit 130 as shown in FIG. 1.

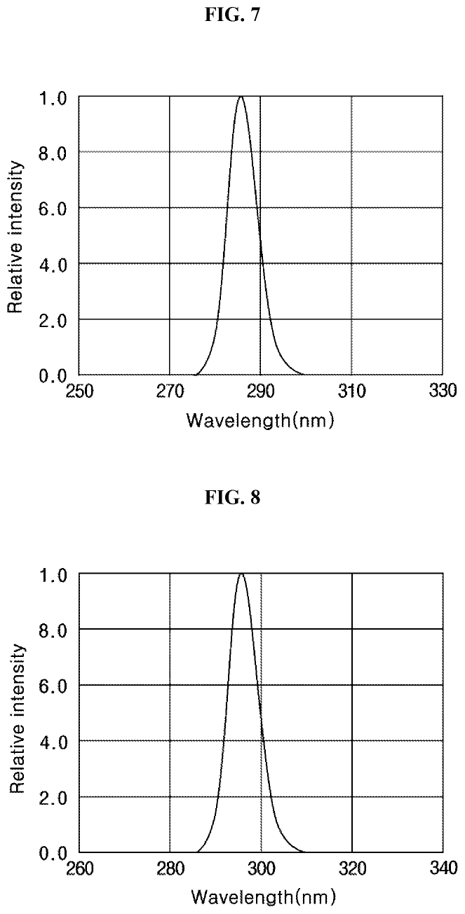

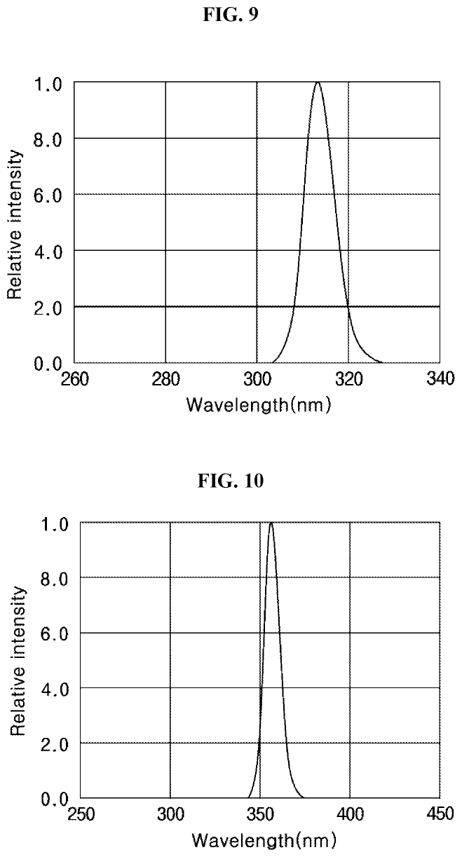

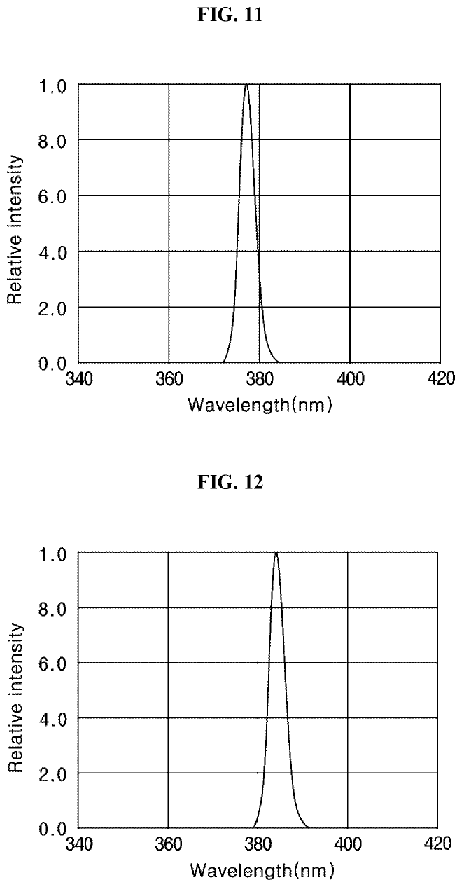

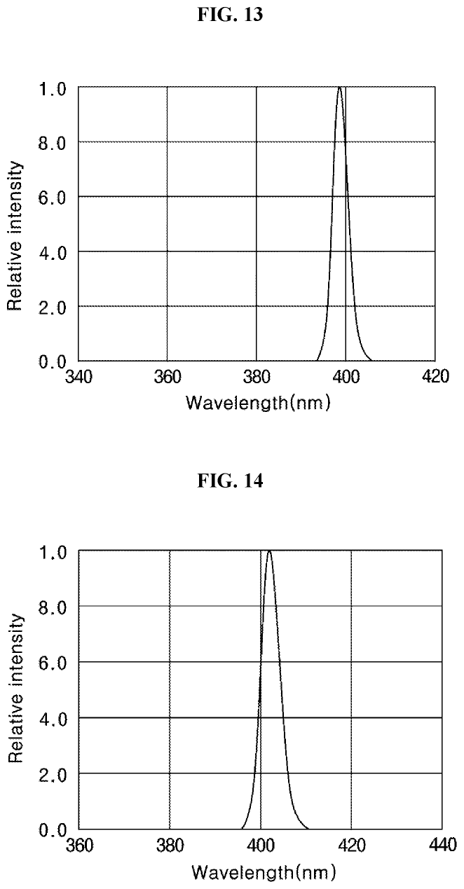

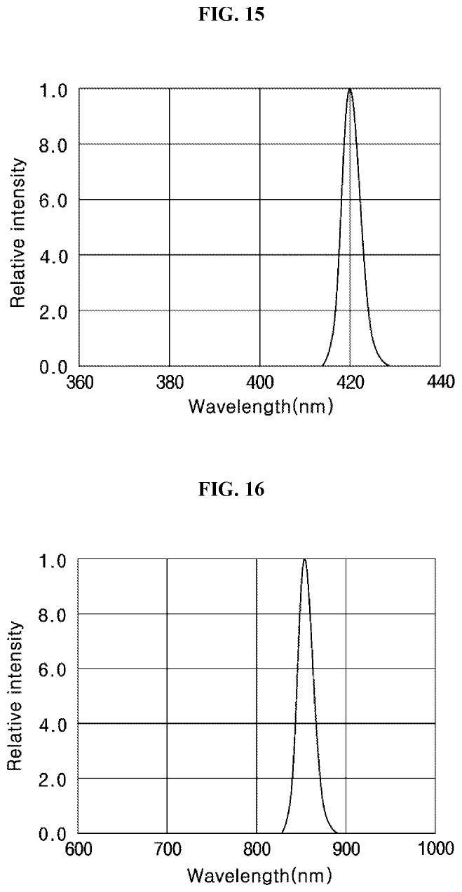

Referring to FIG. 6, the light emitted from the third light source unit 130 may be UVC having a peak in the wavelength range of 270 nm to 280 nm. Referring to FIG. 7, the light emitted from the third light source unit 130 may be UVC having a peak in the wavelength range of 280 nm to 290 nm. Referring to FIG. 8, the light emitted from the third light source unit 130 may be UVB having a peak in the wavelength range of 290 nm to 300 nm. Referring to FIG. 9, the light emitted from the third light source unit 130 may be UVB having a peak in the wavelength range of 300 nm to 320 nm. Referring to FIG. 10, the light emitted from the third light source unit 130 may be UVA having a peak in the wavelength range of 340 nm to 370 nm. Referring to FIG. 11, the light emitted from the third light source unit 130 may be UVA having a peak in the wavelength range of 370 nm to 380 nm. Referring to FIG. 12, the light emitted from the third light source unit 130 may be UVA having a peak in the wavelength range of 380 nm to 390 nm. Referring to FIG. 13, the light emitted from the third light source unit 130 may be UVA having a peak in the wavelength range of 390 nm to 400 nm. Referring to FIG. 14, the light emitted from the third light source unit 130 may be near-UV light having a peak in the wavelength range of 400 nm to 410 nm. Referring to FIG. 15, the light emitted from the third light source unit 130 may be near-UV light having a peak in the wavelength range of 410 nm to 430 nm.

Alternatively, the third type of light emitted from the third light source unit 130 may be infrared light. For example, the third light source unit 130 may include an infrared light source. The infrared light source may include an infrared light emitting diode. Referring to FIG. 16, the third type of light emitted from the third light source unit 130 may have a peak in the wavelength range of 820 nm to 890 nm.

The third light source unit 130 may emit at least one of the different types of light shown in FIG. 6 to FIG. 16. For example, the third light source unit 130 may include a UV light source emitting one of the different types of light shown in FIG. 6 to FIG. 16. Alternatively, the third light source unit 130 may include multiple UV light sources emitting different wavelengths of UV light. Here, each of the multiple UV light sources may emit one of the different types of light shown in FIG. 6 to FIG. 15.

In addition, the multiple UV light sources of the third light source unit 130 may be operated independently of one another. Accordingly, the third type of light emitted from the third light source unit 130 may be one of different wavelengths of UV light, or may be a mixture of different wavelengths of UV light.

As such, the light source module 100 according to this embodiment can provide both light suitable for improving growth of the plant and light suitable for increasing the phytochemical content of the plant. Accordingly, the light source module 100 according to this embodiment can increase the phytochemical content of the plant while improving growth of the plant.

The first light source unit 110, the second light source unit 120, and the third light source unit 130 may be operated independently of one another. That is, the light source module 100 may individually control operation of each of the first light source unit 110, the second light source unit 120, and the third light source unit 130. Accordingly, each of the first light source unit 110, the second light source unit 120, and the third light source unit 130 may emit light separately, or some or all of the light sources may emit light simultaneously with one another.

For example, the first light source unit 110, the second light source unit 120, and the third light source unit 130 may be operated during a light period. Here, operation of the first light source unit 110, the second light source unit 120, and the third light source unit 130 refers to an operation of emitting light. The first light source unit 110, the second light source unit 120, and the third light source unit 130 may be operated simultaneously. Alternatively, the second light source unit 120 and the third light source unit 130 may be operated at different times while the first light source unit 110 is operated.

Alternatively, the first light source unit 110 and the second light source unit 120 may be operated at different times during the light period. Here, the time the third light source unit 130 operates may at least partially overlap the time one of the first light source unit 110 and the second light source unit 120 is operated. Accordingly, during at least a portion of the light period, the third light source unit 130 may be operated simultaneously with either the first light source unit 110 or the second light source unit 120.

Alternatively, at least one of the first light source unit 110 and the second light source unit 120 may operate during the light period and the third light source unit 130 may operate during a dark period.

As such, the first light source unit 110, the second light source unit 120, and the third light source unit 130 may operate in various operation manners.

In addition, each of the first light source unit 110, the second light source unit 120, and the third light source unit 130 may emit light continuously or intermittently. For example, each of the first light source unit 110, the second light source unit 120, and the third light source unit 130 may continue to emit light for a preset period of time. Alternatively, each of the first light source unit 110, the second light source unit 120, and the third light source unit 130 may be repeatedly turned on/off at regular or irregular intervals for a preset period of time. In addition, each of the first light source unit 110, the second light source unit 120, and the third light source unit 130a may also emit light in a different way.

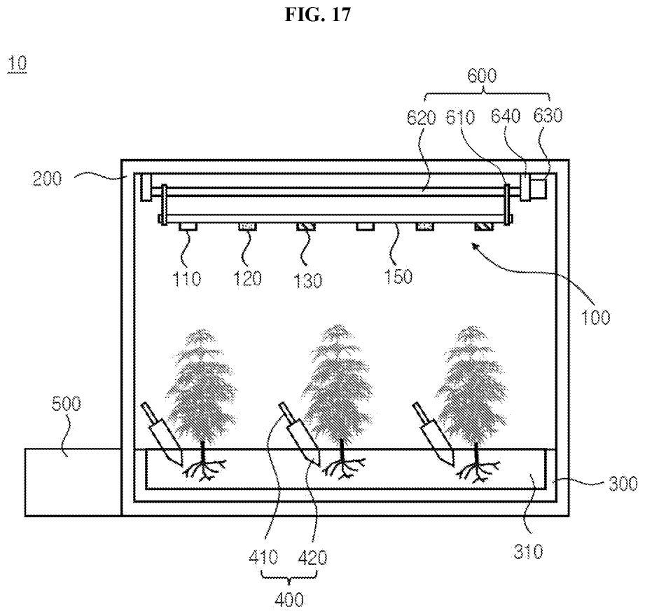

FIG. 17 is an exemplary view of a plant cultivation apparatus 10 according to one embodiment of the present disclosure. Referring to FIG. 17, the plant cultivation apparatus 10 may include a main body 200, a cultivation tray 300, a moisture supply unit 400, a moisture storage unit 500, and a light source module 100.

The main body 200 has an internal space that provides an environment for cultivation of a plant. The size of the main body 200 may vary depending on intended use of the plant cultivation apparatus 10. For example, when the plant cultivation apparatus 10 is for home use, the size of the main body 200 may be smaller than that for commercial use. The main body 200 may be formed of a material impermeable to light so as to prevent external light from entering the internal space. Alternatively, the main body 200 may have an opening or may be formed of a light transmissive material such that external light enters the internal space and is delivered to the plant cultivated in the internal space.

Alternatively, an inner wall of the main body 200 may be formed of a reflective material. Accordingly, it is possible to improve efficiency of light delivery to the plant cultivated in the internal space of the main body 200 through reflection of light from the inner wall of the main body 200.

The cultivation tray 300, the moisture supply unit 400, and the light source module 100 may be disposed in the internal space of the main body 200.

The cultivation tray 300 is adapted for the plant to be planted therein and supports the plant such that the plant does not fall during growth. The cultivation tray 300 may be filled with culture soil 310 needed to grow the plant. In addition, the culture soil 310 may contain nutrients necessary for growth of the plant.

Although the cultivation tray 300 is filled with the culture soil 310 in this embodiment, it should be understood that the present disclosure is not limited thereto. The cultivation tray 300 may be filled with moisture supplied from the moisture supply unit 400 depending on the type of plant cultivated.

The moisture supply unit 400 supplies moisture to the plant. For example, the moisture may be a nutrient solution containing nutrients necessary for growth of the plant. The moisture supply unit 400 may include a moisture supply pipe 410 and a discharge part 420. Although not shown in FIG. 17, the moisture supply pipe 410 is connected to the moisture storage unit 500. Accordingly, moisture stored in the moisture storage unit 500 can be delivered to the discharge part 420 of the moisture supply unit 400 through the moisture supply pipe 410 of the moisture supply unit 400.

Although the moisture storage unit 500 is disposed outside the main body 200 in the plant cultivation apparatus 10 according to this embodiment, it should be understood that the present disclosure is not limited thereto and the moisture storage unit 500 may be disposed inside the main body 200.

According to this embodiment, the discharge part 420 of the moisture supply unit 400, through which moisture is discharged, is embedded in the culture soil 310. Here, the discharge part 420 of the moisture supply unit 400 may be disposed in proximity to the roots of the plant. Accordingly, moisture discharged through the discharge part 420 embedded in the culture soil 310 can be supplied to the roots of the plant directly or through the culture soil 310 near the roots of the plant.

The moisture storage unit 500 stores moisture to be supplied to the plant. That is, the moisture storage unit 500 stores a nutrient solution to be supplied to the plant. The nutrient solution may be prepared by mixing various ingredients in various ratios depending on the type of plant cultivated or the growth status of the plant.

The moisture storage unit 500 may store a readymade nutrient solution. Alternatively, the moisture storage unit 500 may prepare a nutrient solution in response to an input signal indicative of the type of plant or the growth status of the plant. That is, the moisture storage unit 500 may store various recipes for nutrient solution synthesis to prepare a nutrient solution by selecting a recipe corresponding to the input signal.

The moisture supply unit 400 may supply moisture to the plant using drip irrigation. For example, the moisture supply unit 400 may supply the plant with moisture drop by drop through the discharge part 420 embedded in the culture soil 310.

However, it should be understood that the type of moisture supply through the moisture supply unit 400 is not limited thereto. For example, the moisture supply unit 400 may supply moisture to the plant by spraying through a sprinkler, a mist nozzle, or an atomizer depending on the type of plant cultivated. Here, the moisture supply unit 400 may be composed of parts that can implement each of the spraying methods.

The light source module 100 supplies the plant with light needed for growth of the plant. The light source module 100 of the plant cultivation apparatus 10 according to this embodiment is the same as the light source module described with reference to FIG. 1.

As discussed above, according to this embodiment, the light source module 100 may include a support member 150, a first light source unit 110, a second light source unit 120, and a third light source unit 130. The first light source unit 110, the second light source unit 120, and the third light source unit 130 are mounted on the support member 150. The support member 150 may be disposed above the cultivation tray 300 such that light emitted from the first light source unit 110, the second light source unit 120, and the third light source unit 130 is delivered to the plant. The support member 150 may serve as a substrate while supporting the first light source unit 110, the second light source unit 120, and the third light source unit 130.

The first light source unit 110 may emit a first type of light suitable for photosynthesis of the plant. The first type of light emitted from the first light source unit 110 may be visible light. For example, the first type of light may be white light. The first light source unit 110 may provide a day length needed for the plant to grow while helping the plant to perform photosynthesis.

The second light source unit 120 may emit a second type of light suitable for photosynthesis of the plant. The second type of light emitted from the second light source unit 120 may be visible light. Here, the second type of light emitted from the second light source unit 120 may have a different peak wavelength than the first type of light. For example, the second light may be red light.

The third light source unit 130 may emit a third type of light suitable for improving the phytochemical content of the plant. The third type of light emitted from the third light source unit 130 may be at least one selected from among UV light and near-UV light.

The plant cultivation apparatus 10 may include one light source module 100. For example, the light source module 100 may have a structure in which at least one first light source unit 110, at least one second light source unit 120, and at least one third light source unit 130 are mounted on one support member 150.

Alternatively, the plant cultivation apparatus 10 may include multiple light source modules 100. For example, the plant cultivation apparatus 10 may include multiple light source modules 100 each having structure in which at least one first light source unit 110, at least one second light source unit 120, and at least one third light source unit 130 are mounted on one support member 150.

Alternatively, the plant cultivation apparatus 10 may include at least one light source module having a structure in which at least one first light source unit 110 is mounted on a support member, at least one light source module having a structure in which at least one second light source unit 120 is mounted on another support member, and at least one light source module having a structure in which at least one third light source unit 130 is mounted on yet another support member.

As such, the plant cultivation apparatus 10 may include at least one light source module in various forms. The plant cultivation apparatus 10 may further include a moving unit 600 disposed at a top of the internal space of the main body 200. The moving unit 600 may be connected to the light source module 100. That is, the light source module 100 may be secured to the moving unit 600. For example, the support member 150 of the light source module 100 may be secured to the moving unit 600. The moving unit 600 may include a connection part 610, a rotary part 620, a motor 630, and a securing part 640.

The connection part 610 may have one end secured to the rotary part 620 and the other end secured to the support member 150 of the light source module 100.

The securing part 640 serves to secure the moving unit 600 to the main body 200. For example, the rotary part 620 and the motor 630 may be mounted on the securing part 640. Here, one end of the securing part 640 may be secured to the main body 200 using an adhesive, a screw, or the like. Accordingly, the securing part 640 allows the rotary part 620 and the connection part 610 secured to the rotary part 620 to be located at the top of the internal space of the main body 200. The light source module 100 secured to the connection part may also be located at the top of the internal space of the main body 200.

The motor 630 may be connected to the rotary part 620 to rotate the rotary part 620 in one direction or in the reverse direction. The rotary part 620 is rotated by the motor 630. Here, the rotary part 620 may be rotated clockwise or counterclockwise about a longitudinal central axis thereof.

As the rotary part 620 is rotated clockwise, the connection part is wound onto the rotary part 620. As a result, a length of the connection part between the rotary part 620 and the support member 150 of the light source module 100 becomes shorter, causing the light source module 100 to move upwards. Accordingly, a distance between the light source module 100 and the cultivation tray 300 is increased.

As the rotary part 620 is rotated counterclockwise, the connection part is unwound from the rotary part 620. As a result, the length of the connection portion between the rotary part 620 and the support member 150 of the light source module 100 becomes longer, causing the light source module 100 to move downwards. Accordingly, the distance between the light source module 100 and the cultivation tray 300 is decreased.

As such, the moving unit 600 can adjust the distance between the light source module 100 and the plant cultivated in the cultivation tray 300 through winding or unwinding of the connection part.

If the distance between the plant and the light source module 100 is excessively long, light emitted from the light source module 100 can be reduced in intensity before reaching the plant. Accordingly, the intensity of light delivered to the plant can fall short of that needed for growth of the plant and increase in phytochemical content of the plant.

If the distance between the plant and the light source module 100 is excessively short, the plant can be damaged by heat generated from the light source module 100. In addition, if the distance between the plant and the light source module 100 is excessively short, light emitted from the light source module 100 can be blocked by flowers or leaves located at an upper part of the plant. Accordingly, a lower part of the plant can fail to receive a sufficient amount of light due to blockage of light by the upper part of the plant.

With the moving unit 600 adapted to adjust the distance between the plant and the light source module 100 depending on the size of the plant, the plant cultivation apparatus according to this embodiment can supply sufficient light to the entire plant while preventing damage to the plant due to heat generated from the light source module 100.

In this embodiment, the moving unit 600 moves the light source module 100 through rotation of the rotary part. However, it should be understood that a method of moving the light source module 100 is not limited thereto. The moving unit 600 may be a device that can implement various methods to move the light source module 100.

The plant cultivated in the environment provided by the light source module 100 according to the present disclosure, or cultivated in the plant cultivation apparatus 10 may be, for example, cannabis.

Cannabis is an annual herb that grows in humid and temperate climates. Cannabis is dioecious, that is, has a pollen-bearing male flower and a seed-producing female flower on different individuals. It is known that seeds produced in the female flower contain more cannabinoids, which are phenolic compounds, than any other parts of cannabis. Cannabinoids are being studied as stimulants and substances that can treat various diseases such as Parkinson's disease, dementia, and PTSD.

Cannabis has trichomes, or hair-like structures, on flower surfaces thereof. The trichomes contain phytochemicals. Here, the phytochemicals may be cannabinoids. Cannabinoids are compounds that activate cannabinoid receptors in the human brain and body. Examples of cannabinoids include Δ9-tetrahydrocannabinol (Δ9-THC), tetrahydrocannabinolic acid (THCA), Δ8-tetrahydrocannabinol (Δ8-THC), cannabinol (CBN), cannabichromene (CBC), cannabicyclol (CBL), cannabichromenic acid (CBCA), cannabidiol (CBD), cannabidiolic acid (CBDA), cannabigerol (CBG), and cannabigerolic acid (CBGA).

CBD is a non-psychoactive substance and is effective as an anticonvulsant, an anxiolytic, an antipsychotic, an antiemetic, a rheumatoid arthritis drug, and a pain reliever. CBD is used in drugs to treat convulsions in children with epilepsy. THC is a psychoactive substance and is effective as a pain reliever, a tranquilizer, a sleep improver, an appetite promotor, and an antiemetic. THC is used in drugs such as Marinol and Cesamet Canemes. THC is used to treat nausea and vomiting in AIDS patients or chemotherapy patients.

Table 1 shows chemical formulas of CBD and THC.

TABLE 1

| CBD (Cannabidiol) | THC (Tetrahydrocannabinol) |
|---|---|
| 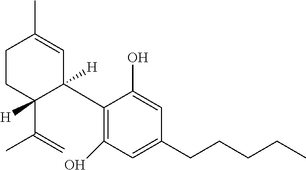 [SMILES: C=C(C)[C@@H]1CCC(C)=C[C@H]1c1c(O)cc(CCCCC)cc1O] | 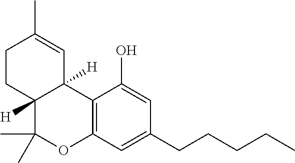 [SMILES: CCCCCc1cc(O)c2c(c1)OC(C)(C)[C@@H]1CCC(C)=C[C@@H]21] |
| CBD | THC |

First, cannabis seeds may be germinated before planting cannabis in the plant cultivation apparatus 10. During the germination stage, the cannabis seeds may be supplied with a sufficient amount of moisture for cells of the cannabis seeds to begin metabolism and grow. For example, the cannabis seeds may be sown in a hydroponic sponge. Here, moisture may be continuously supplied to the sponge such that the cannabis seeds can absorb sufficient moisture. Here, the moisture may be purified water.

The cannabis seeds sown in the sponge may be exposed to visible light until germination. Here, the visible light may be white light or a mixture of white light and red light.

During the germination stage, an 18-hour light period and a 6-hour dark period may be alternated. Here, the visible light may be supplied to the cannabis seeds during the light period. In addition, the visible light may be delivered at an intensity of about 200 μmol/m²s to 300 μmol/m²s.

The germination stage may take about two weeks. The germinated seedlings of cannabis may be transplanted into the cultivation tray 300 of the plant cultivation apparatus 10 according to the embodiment. The germinated seedlings of cannabis may undergo primary growth for about 3 weeks. Although the period of primary growth is set to 3 weeks in this embodiment, it should be understood that the present disclosure is not limited thereto. Herein, the primary growth stage refers to a period of time after planting of the cannabis seedlings and before flowering or fruiting. That is, the primary growth refers to vegetative growth, which is a phase of plant growth between germination and flowering.

During the primary growth stage, an 18-hour light period and a 6-hour dark period may be alternated.

The light source module 100 may deliver light to cannabis at an intensity of about 250 μmol/m²s to about 500 μmol/m²s during the 18-hour light period. For example, the light source module 100 may deliver light to cannabis at an intensity of about 500 μmol/m²s during the light period. Here, the light emitted from the light source module 100 may be the first type of light, the second type of light, or a mixture of at least two of the first type of light, the second type of light, and the third type of light. For example, the first light source unit 110 may continuously emit the first type of light during the light period. Here, the second light source unit 120 may continuously emit the second type of light during the light period, or may continuously or intermittently emit the second type light for a predetermined period of time during the light period. In addition, the third light source unit 130 may emit the third type of light for a predetermined period of time during either the light period or the dark period. Alternatively, the third light source unit 130 may emit the third type of light for a predetermined period of time regardless of photoperiod. Here, the third light source unit 130 may continuously or intermittently emit the third type of light for a predetermined period of time.

During the primary growth stage, the moisture supply unit 400 may supply moisture to the roots of cannabis. For example, the moisture supply unit 400 may supply a nutrient solution to the roots of cannabis once per hour.

Ingredients of the nutrient solution are shown in Table 2. Table 2 shows the amount of each ingredient of stock solutions based on 1 l of water.

TABLE 2

| Stock solution A | | | Stock solution B | | |
|---|---|---|---|---|---|
| KNO₃ | 10.285 | g | NH₄H₂PO₄ | 3.45 | g |
| Ca(NO₃)₂•4H₂O | 7.675 | g | KH₂PO₄ | 3.605 | g |
| EDTA-Fe | 0.75 | g | MgSO₄•7H₂O | 15.22 | g |
| | | | H₃BO₃ | 0.0715 | g |
| | | | MnSO₄•4H₂O | 0.0533 | g |
| | | | ZnSO₄•7H₂O | 0.0055 | g |
| | | | CuSO₄•5H₂O | 0.002 | g |
| | | | Na₂MoO₄•2H₂O | 0.0005 | g |
| | | | HNO₃ | 2.4 | ml |

The nutrient solution supplied to cannabis is prepared by diluting the stock solutions of Table 2 with water. For example, the nutrient solution may be obtained by diluting 4 f of stock solution A and 4 l of stock solution B with 200 l of water. In addition, the nutrient solution may have a hydrogen-ion concentration exponent (pH) of 5.0 to 5.5 and an electrical conductivity (EC) of 0.9 to 1.0.

During the primary growth stage, cannabis may grow stems and leaves. Depending on the growth rate of cannabis, topping may be performed two weeks after beginning of the primary growth stage. Topping may induce side branches by cutting off a shoot tip where a growing point of the plant is located. That is, topping can prevent the plant from growing more upwards by cutting off of the shoot tip where the growing point of the plant is located, while allowing more branches, from which leaves will grow, to arise from a main stem of the plant. In addition, topping can prevent the plant from falling due to overgrowth.

During growth of the plant in the plant cultivation apparatus 10, a proper distance may be maintained between the plant and the light source module 100 using the moving unit 600. For example, the moving unit 600 may adjust the location of the light source module 100 such that a distance of about 30 cm is maintained between the plant and the light source module 100.

As the plant continues to grow, the plant becomes closer to the light source module 100, making it difficult to maintain the proper distance between the plant and the light source module 100. Then, the plant can be damaged by heat from the light source module 100.

As such, topping cannabis depending on the growth rate of cannabis can prevent cannabis from falling or being damaged by heat from the light source module 100 while increasing the number of branches from which flowers will emerge.

After the primary growth stage, cannabis may undergo secondary growth for about 9 weeks. Here, secondary growth refers to reproductive growth, which results in flowering of cannabis. Although the period of secondary growth is set to 9 weeks in this embodiment, it should be understood that the present disclosure is not limited thereto. The secondary growth stage refers to a period of time after flowering or fruiting of the plant and before harvest of flowers or fruits. That is, during the secondary growth stage, cannabis produces flowers and the flowers grow to maturity.

Cannabis is a plant that requires a day length of about 13 to 14 hours or less to flower. Accordingly, during the secondary growth stage, a 12-hour light period and a 12-hour dark period may alternate. That is, during the secondary growth stage, the light period per day may be set to about 13 to 14 hours or less.

In addition, the light source module 100 may supply cannabis with light at an intensity of about 700 μmol/m²s to 1,100 μmol/m²s during the light period. For example, the light source module 100 may supply cannabis with light at an intensity of about 1,000 μmol/m²s during the light period. Here, the light emitted from the light source module 100 may be the first type of light, the second type of light, or a mixture of at least two of the first type of light, the second type of light, and the third type of light. For example, the first light source unit 110 may continuously emit the first type of light during the light period. Here, the second light source unit 120 may continuously emit the second type of light during the light period, or may continuously or intermittently emit the second type light for a predetermined period of time during the light period. In addition, the third light source unit 130 may emit the third type of light for a predetermined period of time during either the light period or the dark period. Alternatively, the third light source unit 130 may emit the third type of light for a predetermined period of time regardless of photoperiod. Here, the third light source unit 130 may continuously or intermittently emit the third type of light for a predetermined period of time.

Although the amount of light supplied to cannabis from the light source module 100 during the primary growth stage is different from the amount of light during the secondary growth stage in this embodiment, it should be understood that the present disclosure is not limited thereto. The amount of light supplied to cannabis from the light source module 100 during the primary growth stage may be the same as the amount of light during the secondary growth stage. In addition, the amount of light supplied to cannabis from the light source module 100 is not limited to the above range. For example, the light source module 100 may supply cannabis with light at an intensity of about 35 to 40 mol/m²/day. This is a proper daily dose of light effective for cannabis plants.

As such, the light source module 100 according to the embodiments and the plant cultivation apparatus 10 including the light source module 100 can supply the plant with an appropriate amount of light for each growth stage through adjustment of intensity depending on the growth stage of the plant.

During the secondary growth stage, stems, leaves, and flowers of cannabis grow more actively than during the previous stage. Accordingly, the moisture supply unit 400 may be set to supply an increased amount of moisture to cannabis to meet increased nutrient requirements of cannabis.

During the secondary growth stage, the moisture supply unit 400 may supply a nutrient solution to the roots of cannabis every 30 minutes.

Cannabis has trichomes, or hair-like structures, on flower surfaces thereof. The trichomes contain phytochemicals.

When the flowers of cannabis are not yet mature, the head of the trichomes appears transparent. When the flowers of cannabis are excessively mature, the head of the trichomes turns brown, which means reduction in phytochemical content of the flowers.

Accordingly, in order to efficiently obtain phytochemicals, it is desirable that cannabis be harvested when the flowers of cannabis are mature enough to cause the head of the trichomes to turn white.

In addition, the light source module according to the embodiments and the plant cultivation apparatus including the light source module can improve the phytochemical content of harvested cannabis during storage through delivery of light to harvested cannabis or cannabis flowers.

Further, the light source module according to the embodiments and the plant cultivation apparatus including the light source module can improve the phytochemical content of every part of cannabis, including leaves, stems, and flowers, by uniformly delivering light to the entire plant. Moreover, the plant cultivation apparatus according to the embodiments can variously change illumination conditions such as the type, duration, and intensity of light radiation depending on whether a cannabis plant to be cultivated is a male plant or a female plant. Accordingly, the plant cultivation apparatus according to the embodiments can efficiently improve the phytochemical content of cannabis by providing appropriate illumination for each of male and female cannabis plants.

In addition, the light source module according to the embodiments and the plant cultivation apparatus including the light source module can selectively increase the content of a specific phytochemical through adjustment of illumination conditions.

The plant cultivation apparatus according to the embodiments can adjust photoperiod, light intensity, and supply of moisture depending on the growth stage of the plant. In addition, the plant cultivation apparatus according to the embodiments can prevent damage to the plant due to heat from the light source module while allowing the entire plant to be exposed to light through control of the distance between the plant and the light source module. Further, the plant cultivation apparatus according to the embodiments can promote growth of the plant while increasing the phytochemical content of the plant by supplying the plant with various wavelengths of light.

Although the light source module and the plant cultivation apparatus according to the embodiments have been described as being applied to cannabis, it should be understood that the present disclosure is not limited thereto and the light source module and the plant cultivation apparatus according to the embodiments may be applied to various other plants. However, depending on the species, there may be differences in effect of the same type of light and the same light intensity on change in photosynthetic efficiency or content of phytochemicals.

Although some embodiments have been described herein, it should be understood that these embodiments are provided for illustration only and are not to be construed in any way as limiting the present disclosure. Therefore, the scope of the present disclosure should be defined by the appended claims and equivalents thereto.

1. A light source module comprising:
a first light source unit emitting a first type of light suitable for growing a target plant;
a second light source unit emitting a second type of light suitable for growing the target plant; and
a third light source unit emitting a third type of light suitable for increasing content of phytochemicals in the target plant,
wherein the first light source unit, the second light source unit, and the third light source unit are operated independently of one another,
the first type of light and the second type light are visible light and have different peak wavelengths from each other, and
the third type of light comprises at least one selected from among UVA, UVB, UVC, and near-UV light.

2. The light source module according to claim 1, wherein the first light source unit, the second light source unit, and the third light source unit are operated simultaneously during a preset light period.

3. The light source module according to claim 1, wherein the first light source unit and the second light source unit are operated during a preset light period, the first light source unit and the second light source unit being operated simultaneously for at least some period of time.

4. The light source module according to claim 3, wherein the third light source unit is operated for at least a portion of a period of time for which the first light source unit is operated.

5. The light source module according to claim 3, wherein the third light source unit is operated for at least a portion of a period of time for which the second light source unit is operated.

6. The light source module according to claim 3, wherein the third light source unit is operated during a preset dark period.

7. The light source module according to claim 1, wherein the light source module supplies the target plant in a primary growth stage with light having an intensity of about 500 μmol/m²s during a preset period of a light period, where the light period is 18 hours, and a dark period is 6 hours,
wherein the primary growth stage is a period of time after planting of the target plant in a cultivation tray and before flowering or fruiting of the target plant.

8. (canceled)

9. The light source module according to claim 1, wherein the light source module supplies the target plant in a secondary growth stage with light having an intensity of about 1,000 μmol/m²s during a preset period of a light period, where the light period is 12 hours, and a dark period is 6 hours,
wherein the secondary growth stage is a period of time after the primary growth stage and before harvest of flowers or fruits of the target plant.

10. (canceled)

11. The light source module according to claim 1, wherein the phytochemicals comprise cannabinoids.

12. The light source module according to claim 11, wherein the phytochemicals comprise at least one selected from among Δ9-tetrahydrocannabinol (Δ9-THC), tetrahydrocannabinolic acid (THCA), Δ8-tetrahydrocannabinol (Δ8-THC), cannabinol (CBN), cannabichromene (CBC), cannabicyclol (CBL), cannabichromenic acid (CBCA), cannabidiol (CBD), cannabidiolic acid (CBDA), cannabigerol (CBG), and cannabigerolic acid (CBGA).

13. (canceled)

14. A plant cultivation apparatus comprising:
a cultivation tray adapted to allow a target plant to be planted therein and supporting the target plant during growth,
a moisture supply unit supplying moisture to the target plant; and
a light source module disposed above the cultivation tray and supplying light to the target plant during at least one of preset light and dark periods, the light source module comprising:
a first light source unit emitting a first type of light suitable for growing the target plant,
a second light source unit emitting a second type of light suitable for growing the target plant, and a third light source unit emitting a third type of light suitable for increasing content of phytochemicals in the target plant,
wherein the first light source unit, the second light source unit, and the third light source unit are operated independently of one another,
the first type of light and the second type light are visible light having different peak wavelengths, and
the third type of light comprises at least one selected from among UVA, UVB, UVC, and near-UV light.

15. The plant cultivation apparatus according to claim 14, wherein the first light source unit, the second light source unit, and the third light source unit are operated simultaneously during the light period.

16. The plant cultivation apparatus according to claim 14, wherein the first light source unit and the second light source unit are operated during the light period, the first light source unit and the second light source unit being operated simultaneously for at least some period of time.

17. The plant cultivation apparatus according to claim 16, wherein the third light source unit is operated for at least a portion of a period of time for which the first light source unit is operated.

18. The plant cultivation apparatus according to claim 16, wherein the third light source unit is operated for at least a portion of a period of time for which the second light source unit is operated.

19. The plant cultivation apparatus according to claim 16, wherein the third light source unit is operated during the dark period.

20. The plant cultivation apparatus according to claim 14, further comprising:
a moving unit moving the light source module to adjust a distance between the light source module and the target plant.

21. The plant cultivation apparatus according to claim 20, wherein the moving unit controls a location of the light source module such that a distance of about 30 cm is maintained between the light source module and the target plant.

22. The plant cultivation apparatus according to claim 14, further comprising:
a moisture storage unit storing moisture to be supplied to the moisture supply unit.

23. The plant cultivation apparatus according to claim 14, wherein the moisture is a nutrient solution containing nutrients needed by the plant.

24-30. (canceled)
